(19) United States
(12) Patent Application Publication
(10) Pub. No.: US 2025/0128374 A1
(43) Pub. Date: Apr. 24, 2025

(54) Workpiece carrier

(71) Applicant: ZEROCLAMP GmbH, Bruckmühl (DE)

(72) Inventor: Klaus Hofmann, Bruck (DE)

(21) Appl. No.: 18/923,906

(22) Filed: Oct. 23, 2024

(30) Foreign Application Priority Data
Oct. 24, 2023 (DE) 10 2023 129 241.2

(51) Int. Cl. B23Q 7/04

(52) U.S. Cl. CPC B23Q 7/046; B23Q 2703/04

(57) ABSTRACT

The invention relates to a workpiece carrier for arrangement in a machine tool. The workpiece carrier includes multiple pneumatic workpiece holders as well as a compressed air reservoir, pneumatic valves, a control unit, and an accumulator as a voltage supply, so that the workpiece carrier can hold a plurality of workpieces and be wirelessly activated by an external robot controller in order to clamp workpieces in the workpiece holders or remove workpieces therefrom.

### REFERENCE TO PENDING PRIOR PATENT APPLICATION

This patent application claims benefit of German Patent Application No. 10 2023 129 241.2, filed Oct. 24, 2023, which patent application is hereby incorporated herein by reference.

### FIELD OF THE INVENTION

The present invention relates to a workpiece carrier for holding multiple workpieces to allow the workpiece carrier, together with the workpieces for machining, to be situated in a machine tool.

### BACKGROUND OF THE INVENTION

In the machining of parts in machine tools, for example in horizontal milling machines, several parts are often machined simultaneously in so-called multiple clampings. For this purpose, a workpiece carrier includes multiple workpiece holders, each of which can clamp a part (also referred to below as a workpiece). During the machining, another, identical workpiece carrier outside the machine tool or at a setup station may be fitted with new workpieces for the next machining cycle.

Manual fitting of the workpiece carrier is time-consuming and costly, so that a robot is often the better choice. However, the problem here is that for the workpiece holders, energy feeds, which generally must be passed through using rotary leadthroughs, must be provided in the workpiece carrier. For many machines, this involves significant effort.

### SUMMARY OF THE INVENTION

The object of the invention, therefore, is to provide a workpiece carrier that manages without the installation of energy feeds, but that can still be fitted using robots. The object is achieved by a workpiece carrier according to claim 1. Further advantageous embodiments result from the subclaims.

The invention is based on the finding that a workpiece carrier can advantageously be inserted into a machine tool and on the other hand fitted using a robot when the workpiece carrier can be operated independently of an external power supply. It is then possible to dispense with the complex rotary leadthroughs, which have a complicated design. At the same time, the workpiece carrier may be fitted using a robot when the individual workpiece holders can be activated via a control unit that is part of the workpiece carrier, and the control unit can communicate wirelessly with an external controller, for example a robot controller. The robot can thus “indirectly” activate the individual workpiece holders of the workpiece carrier to allow a workpiece at that location to be clamped or released. At the same time, the robot can insert the workpiece in question into the workpiece holder or remove it therefrom.

According to a first embodiment of the invention, the workpiece carrier includes at least one pneumatically operated workpiece holder in which a workpiece may be temporarily fixed. In particular, the workpiece holder may be a pneumatic vice or a chuck based on WO 2007/009439 A1. Such a workpiece holder is preferably designed in such a way that its clamping means are transferred into a released state by the action of compressed air, so that a workpiece may be removed from or inserted into the clamping means (workpiece exchange). When the action of the compressed air ends (rest state), the clamping means of the workpiece holder assume a clamping state, so that a workpiece that is held by the clamping means is securely fixed. This clamping state may be produced, for example, by a spring mechanism in the clamping means. An element to be fixed in such a spring mechanism is clamped, using specialized pressurizable springs, until a pressure that sufficiently counteracts the clamping builds up and then releases the clamping. In the relaxed (pressureless) state the part is thus securely clamped.

Alternatively or additionally, the clamping may take place without a spring mechanism by means of a central compressed air reservoir, or a local compressed air reservoir associated with each workpiece holder. The workpiece holder may also be designed in such a way that both the clamping state and the released state are brought about by compressed air, which selectively acts on suitable pneumatic means of the workpiece holder.

Theoretically, a function would also be conceivable in which the workpiece holder clamps the workpiece when acted on by compressed air, and otherwise releases the workpiece. However, for safety reasons it is preferred to keep the workpiece clamped when there is a lack of compressed air, for example due to a failure of the compressed air supply.

A central compressed air reservoir that is part of the workpiece carrier is provided to allow the workpiece holders to be supplied with compressed air. The compressed air supply to each workpiece holder may be enabled or interrupted via suitable electropneumatic valves of the workpiece carrier, known per se to those skilled in the art.

In addition, the workpiece carrier includes a control unit for activating in particular the electropneumatic valves and thus allowing the workpiece holder to be transferred into the clamped or released state. According to the invention, the control unit also includes a wireless communication interface. Via this interface the control unit can receive signals from an external controller, in particular a robot controller of a robot that is placed in the vicinity of the workpiece carrier. The communication takes place wirelessly to avoid a cable connection to the workpiece carrier. The wireless communication may take place according to standards and protocols known per se, for example via a wireless local area network (WLAN). Other wireless communication means, standards, and protocols known to those skilled in the art may likewise be suited.

Lastly, the workpiece carrier includes a voltage supply, designed as a rechargeable battery (accumulator), for supplying all electrically operated components of the workpiece carrier with voltage. These components include in particular the electropneumatic valves and the control unit together with its communication interface.

Workpiece carriers designed in this way may also be operated autonomously with respect to the outside, i.e., without a connection to a power or media supply (assuming an adequate charging state of the accumulator and filling state of the compressed air reservoir). The workpiece carrier may thus be moved and transferred in a production room as desired, for example moved from a setup station into a machine tool and back, without having to provide or interrupt a power supply or compressed air supply for the operation. The workpiece carrier may be autonomously actuated at the setup station, for example in that the controller of a robot, in wireless communication with the control unit of the workpiece carrier, activates the individual workpiece holders for releasing or clamping workpieces. The accumulator provides the necessary electrical power for the control unit and the electropneumatic valves, while the central compressed air reservoir delivers the necessary compressed air for acting on the workpiece holders.

According to one advantageous embodiment of the invention, the workpiece carrier contains one or more sensors, whose signals are preferably led to the control unit to allow operating states of the workpiece carrier to be detected. In particular, these may be sensors for detecting the charging state of the accumulator or the voltage provided by same. Also conceivable are sensors for detecting the action of compressed air on pneumatically operated components of the workpiece carrier, which include in particular the central compressed air reservoir or the workpiece holders. Thus, for example, a sensor could detect the pressure in the central compressed air reservoir and signal this pressure value to the control unit. If the pressure drops below a critical threshold value, the control unit could then send an appropriate signal to the outside via the wireless communication interface, for example to a higher-level controller. The switching state of individual electropneumatic valves or of the associated workpiece holders may also be monitored and signaled by use of sensors in order to activate the individual workpiece holders in a controlled manner. Further sensors for detecting the operational readiness of the workpiece carrier or of its control unit may also be provided, for example a watchdog. Thus, between the control unit of the workpiece carrier and a higher-level controller, codes could be exchanged which would have to be acknowledged in order to recognize that one or both controllers are still operating properly.

The control unit may also include a data memory in which sequential programs may be stored. The memory may also be used to store and/or read out as needed the signals or measured values transmitted by the sensors and optionally converted by the control unit. Of course, if necessary the data stored in the memory may also be transmitted via the wireless communication interface to a higher-level controller outside the workpiece carrier.

Although the workpiece carrier according to the invention offers the stated advantages with only one provided workpiece holder, multiple workpiece holders are advantageously provided to allow fixing of multiple workpieces simultaneously and supplying them to machining by a machine tool. An individual workpiece holder could be situated, for example, on a top side of the workpiece carrier. Multiple workpiece holders could, for example, be positioned at the workpiece carrier with a symmetrical distribution, for example one or more workpiece holders on each side, with or without an additional workpiece holder on the top side of the workpiece carrier.

According to one advantageous embodiment of the invention, the workpiece carrier is designed as a tensioning tower. In that case, it extends in the manner of a tower with the basic shape of a preferably regular prism, along a vertical axis around which multiple side faces, preferably with approximately the same design, are formed. One workpiece holder, preferably at least two workpiece holders that are superposed in the vertical direction, is/are situated on each side face. A workpiece carrier having two, three, four, or even more adjoining side faces in each case around a vertical axis is conceivable, each of the side faces having at least one workpiece holder. It is thus possible to fix a plurality of workpieces on a relatively small space. A particularly preferred embodiment has four vertical side faces extending at right angles to one another, each with four overlying workpiece holders for each side face.

It is thus possible to simultaneously fix up to sixteen workpieces on a comparatively narrow space. Such an embodiment also optimally takes into account the space constraints in a machine tool, in particular a horizontal milling machine.

The outer faces forming the prism at the same time describe a type of housing of the workpiece carrier, within which, for example, the central compressed air reservoir, the accumulator, the electropneumatic valves, sensors, and further components of the device may be situated. The stated components are preferably modularly exchangeable, for example via access on the top side of the housing.

According to a further advantageous embodiment of the invention, it is provided that the workpiece holders are individually activatable, in predefinable groups or all at the same time. Thus, for example, it may be advantageous to simultaneously transfer all workpiece holders on one side of a workpiece carrier or tensioning tower that is four-sided, for example, into the released state to allow the workpieces resting in the workpiece holders to be simultaneously or successively removed therefrom, preferably with robot assistance. However, the further workpiece holders on the remaining sides of the workpiece carrier remain in the clamping state in order to continue to hold clamped the workpieces situated there.

Alternatively, the targeted activation of individual workpiece holders may take place in order to precisely remove a workpiece from the holder in question or insert it therein, while the other workpiece holders maintain their state (clamping or released) unchanged. In addition, it may be helpful or necessary to transfer all workpiece holders simultaneously into the released state, for example to allow all workpieces to be removed at the same time.

According to the invention, the activation of the valves associated with the respective workpiece holders takes place by use of the control unit. A program stored in the control unit which runs as a function of certain signals supplied to the control unit may be used for this purpose. This may also involve signals from the sensors of the workpiece carrier. The control unit preferably receives signals from the external controller, in particular a robot controller, via the wireless communication interface. These types of signals may be processed in the control unit and in particular used for activating the electropneumatic valves.

Alternatively or additionally, however, according to a further embodiment of the invention control elements that are to be actuated manually may be provided at the workpiece carrier. These may be used to directly activate individual workpiece holders or groups of workpiece holders in order to transfer them into a state that clamps the workpiece or releases the workpiece. This may take place by transmitting a suitable signal to the control unit, for example via wire, by actuating a control element that is designed as an electrical switch or button. Alternatively, a control element could directly connect a voltage to a valve by actuating the control element while bypassing the control unit. Lastly, it would also be conceivable to design a control element directly as a valve that is to be manually actuated and that supplies a workpiece holder with compressed air to ensure the operability of the workpiece carrier independently of a power supply, for example in the event of a power failure.

According to a further advantageous embodiment of the invention, it is provided that the workpiece carrier has at least one air delivery nozzle via which the compressed air reservoir may be filled with compressed air from an external compressed air source. If necessary, the compressed air reservoir may then be temporarily connected to a compressed air source, for example a compressed air network in a production room, via the compressed air nozzle in order to load the compressed air reservoir. The air delivery nozzle is advantageously connected to such an external compressed air source by use of a robot. This may take place when compressed air is needed, or also regularly, for example within the scope of fitting the workpiece carrier with new workpieces. Although compressed air is a particularly suitable medium for operating the workpiece holders, as an alternative some other fluid such as hydraulic oil could be considered, depending on the requirements and the nature of the workpiece holders. In that case, additional pressure means could be necessary in the workpiece carrier to allow the fluid to be provided at the required pressure during autonomous operation. Suitable sensors and connections for this fluid are obtained analogously to those described with regard to compressed air.

Alternatively or additionally, the workpiece carrier may include a compressor in order to generate the required compressed air itself. For this purpose, the compressor may be supplied with voltage from the accumulator or may be appropriately activated by the control unit. If the pressure detected in the compressed air reservoir, for example, dropped below a pressure threshold value, the workpiece carrier would then be able to independently put the compressor in operation and automatically refill the reservoir. The air delivery nozzle for the external compressed air supply may likewise be kept ready to allow the compressor to be supplied with the necessary compressed air, for example if the compressor fails.

The accumulator preferably includes a plug connection for temporary connection to an external power supply for recharging the accumulator. The connection may take place via a plug connection at the accumulator, into which a power supply may be plugged in. This connection may also be established by the above-mentioned robot, regularly or as needed. Alternatively, however, the accumulator is preferably exchangeable, i.e., modularly removable from or insertable into the workpiece carrier, so that an accumulator may be charged outside the workpiece carrier, and in the charged state inserted into the workpiece carrier. As the result of an accumulator exchange without a disruptive charging time, the workpiece carrier may be supplied with a freshly charged voltage supply which has already been charged beforehand. The accumulator exchange could also take place with robot assistance.

The workpiece carrier according to the invention may be utilized particularly advantageously in conjunction with a robot that is designed to insert workpieces into the workpiece holders of the workpiece carrier or remove workpieces therefrom. For this purpose, the robot preferably includes a robot controller that is designed to transmit signals to the control unit of the workpiece carrier via the wireless communication interface and/or to receive signals from same. The robot controller may also be designed to activate fitting means, such as an arm of the robot, for example to insert workpieces that are waiting in a magazine into the workpiece holders of the workpiece carrier, or to remove workpieces therefrom and return them to the magazine. The robot controller then takes over control of the robot arm and also of the workpiece carrier or its workpiece holders.

The arrangement of workpiece carriers and robots may thus be advantageously utilized to fit the workpiece carrier (at a setup station, for example) with workpieces for pending machining in a machine tool. For machining the workpieces, the completely fitted workpiece carrier may then be transferred into the machine bed of a machine tool, for example likewise by use of the robot that performs the fitting. It is advantageous that no electrical or pneumatic supply lines for the workpiece carrier are necessary in the machine tool, since according to the invention the workpiece carrier operates autonomously. If necessary, some other external controller or the controller of the machine tool may also be designed to wirelessly transmit signals to the controller of the workpiece carrier, for example to influence certain operating states of the workpiece carrier or its workpiece holders, or to receive signals or error messages from the control unit, during the machining of the workpieces in the machine tool.

### BRIEF DESCRIPTION OF THE DRAWINGS

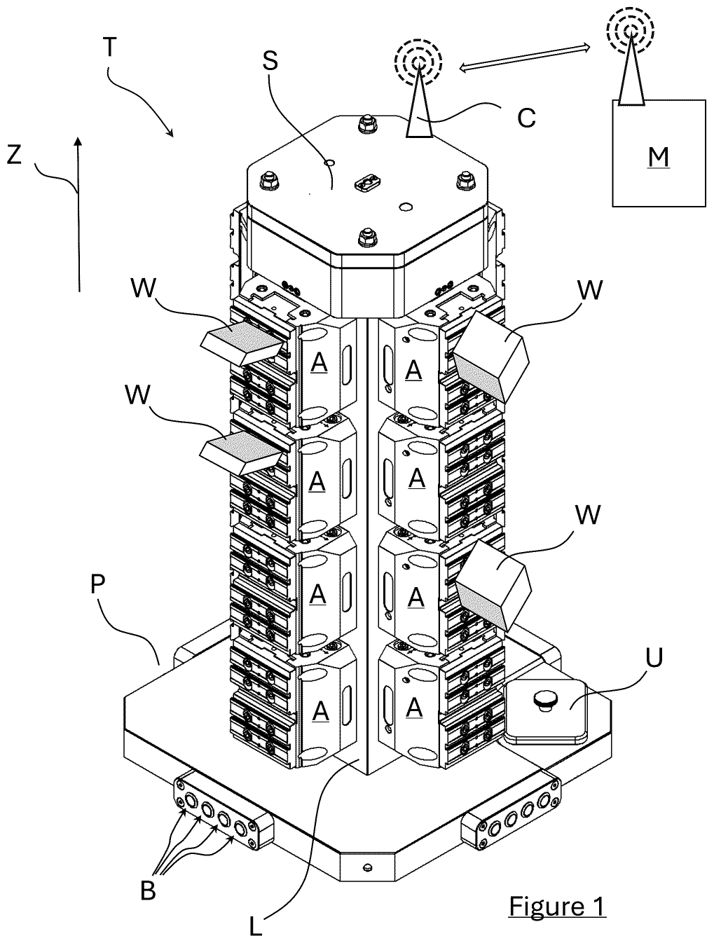

One embodiment of the invention is explained in greater detail below based on an example in the figure. The single FIG. 1 shows a simplified perspective view of a workpiece carrier T according to the invention which is designed as a tensioning tower.

### DETAILED DESCRIPTION OF THE PREFERRED EMBODIMENTS

The workpiece carrier, starting from a bottom, essentially square base plate P, extends in a vertical direction Z in an essentially cuboidal manner, and on four side faces oppositely situated in pairs, in each case four workpiece holders A are situated one on top of the other in the vertical direction Z. Some workpiece holders are illustrated with workpieces W clamped therein. Each of the total of 16 workpiece holders is designed as a pneumatically operable vice. The space enclosed by the workpiece holders A is used at the same time as a housing for a central compressed air reservoir L, and a control unit S which has a wireless communication interface C.

The wireless communication interface C is designed for signal exchange with a higher-level controller M, which in the exemplary embodiment shown is also the controller of a robot, not illustrated in greater detail.

The individual workpiece holders A are supplied with compressed air by the control unit S and via electropneumatic valves, not visible in FIG. 1, and for this purpose the compressed air is removed from the compressed air reservoir L. The workpiece carrier T also includes a rechargeable battery (accumulator) U for supplying power to the control unit S and the valves

Also provided on each side of the workpiece carrier T, in the area of the base plate P, are four manually operable control elements B, via which a workpiece holder A of the respective side may in each case be transferred into the clamping or released state. These control elements are provided in particular in the event of a power failure or as a rapid response option for an on-site operator, without having to wirelessly communicate with the control unit S.

Not illustrated in greater detail in FIG. 1 is an air delivery nozzle to which an external compressed air supply may be temporarily connected in order to fill the compressed air reservoir L. Also not illustrated is a plug connection at the accumulator U, via which the accumulator may be temporarily connected to an external power supply for charging.

The robot, which is part of the robot controller M, is likewise not illustrated. This may be a robot, known per se by those skilled in the art, that is designed to fit the workpiece carrier T with individual workpieces and to insert the workpieces into the individual workpiece holders A of the workpiece carrier T. In addition to this function, the robot controller M also takes over the communication with the control unit S of the workpiece carrier in order to prompt the control unit to release or to fix/clamp a workpiece in the particular workpiece holder A that the robot intends to fit with a workpiece.

### LIST OF REFERENCE SYMBOLS

A workpiece holder
B control elements
C wireless communication interface
L compressed air reservoir
M external (robot) controller
P base plate
S control unit
T workpiece carrier
U accumulator/voltage supply

1. A workpiece carrier (T) for arrangement in a machine tool, the workpiece carrier (T) including the following:
a) at least one pneumatically operated workpiece holder (A) for temporarily holding workpieces (W),
b) a central compressed air reservoir (L) for supplying the at least one workpiece holder (A),
c) pneumatic valves for enabling or interrupting the compressed air supply to the at least one workpiece holder (A),
d) a control unit(S) for actuating the pneumatic valves,
e) wherein the control unit(S) includes a wireless communication interface (C) for wirelessly transmitting signals between the control unit(S) and a higher-level controller (M), in particular a robot controller, and
f) a voltage supply (U), designed as an accumulator, for the electrically operated components of the workpiece carrier (T),
wherein the workpiece carrier (T) is designed as a device that is independent of an external power supply during operation.

2. The workpiece carrier (T) according to claim 1, wherein the at least one workpiece holder (A) is designed as a pneumatic vice or chuck that is activated via electropneumatic valves by means of the control unit(S) in order to clamp or release a workpiece (W).

3. The workpiece carrier (T) according to claim 1, characterized in that each workpiece holder (A) is transferred into a released state by the action of pressure in order to release a clamped workpiece, whereas in the absence of the action of pressure (rest state) the workpiece holder (A) is transferred into a clamping state via which a workpiece inserted into the workpiece holder (A) is fixedly clamped.

4. The workpiece carrier (T) according to claim 1, further including at least one sensor for detecting
a) the charging state and/or the voltage of the voltage supply (U), and/or
b) the action of compressed air on at least one pneumatically operated component of the workpiece carrier (T), in particular the central compressed air reservoir (L) or a workpiece holder (A), and/or
c) the operational readiness of the control unit(S).

5. The workpiece carrier (T) according to claim 1, characterized in that the workpiece carrier (T) extends about a vertical axis (Z) with the basic shape of a prism, preferably a regular prism, most preferably a cube, wherein on multiple, preferably all, vertical side faces of the prism
a) a workpiece holder (A) is situated
or
b) at least two workpiece holders (A) are situated one on top of the other in the vertical direction (Z).

6. The workpiece carrier (T) according to claim 1, characterized in that the workpiece carrier (T) has four vertical sides, each with four workpiece holders (A) situated one on top of the other in the vertical direction, to provide a total of sixteen workpiece holders (A).

7. The workpiece carrier (T) according to claim 1, characterized in that the workpiece holders (A) are individually activatable, in predefinable groups or collectively, in order to clamp or release a workpiece (W).

8. The workpiece carrier according to claim 1, further including manually actuatable control elements (B) in order to act on pneumatically operated components of the workpiece carrier (T) with compressed air or separate them
from the compressed air, as an alternative to the control unit(S) or in the event of a malfunction.

9. The workpiece carrier according to claim 1, characterized in that a workpiece holder (A) or a selection of multiple workpiece holders (A) is associated with each control element (B), so that by manually actuating the particular control element (B), the associated workpiece holder (A) or the workpiece holder selection is transferable into a state that clamps or releases a workpiece.

10. The workpiece carrier according to claim 1, characterized in that
a) at least one air delivery nozzle is provided, via which the compressed air reservoir (L) may be filled with compressed air from an external compressed air source,
and/or
b) the workpiece carrier (T) includes a compressor that is connectable to the voltage supply in order to fill the compressed air reservoir (L) with compressed air.

11. An arrangement of a robot and a workpiece carrier (T) according to claim 1, wherein the robot has
a) a robot controller (M) that is designed to wirelessly transmit signals to the control unit(S) of the workpiece carrier and/or to receive signals from same, and
b) fitting means for automatically inserting workpieces, provided in the operating area of the robot, into the workpiece holders (A) of the workpiece carrier (T) or removing them from the workpiece holders (A).

12. The arrangement according to claim 1, characterized in that the robot is designed to temporarily connect the workpiece carrier (T) to an external compressed air supply or voltage supply in order to fill the compressed air reservoir (L) with compressed air or supply the accumulator with power, respectively.

13. The workpiece carrier according to claim 1, characterized in that an accumulator is modularly removable from or insertable into the workpiece carrier (T) so that an accumulator is charged outside the workpiece carrier (T), and in the charged state is insertable into the workpiece carrier (T).
